(19) United States
(12) Patent Application Publication
(10) Pub. No.: US 2026/0230239 A1
(43) Pub. Date: Aug. 6, 2026

(54) SYSTEMS AND METHOD FOR ADDRESSING COLLISIONS IN WIRELESS COMMUNICATIONS

(71) Applicant: Sharp Kabushiki Kaisha, Sakai City (JP)

(72) Inventors: Majid GHANBARINEJAD, Lake Forest, CA (US); Zhanping YIN, Vancouver, WA (US); Tomoki YOSHIMURA, Camas, WA (US); Atsushi ISHII, Vancouver, WA (US)

(21) Appl. No.: 19/046,354

(22) Filed: Feb. 5, 2025

(51) Int. Cl. H04L 1/1867; H04L 1/1822; H04W 56/00

(52) U.S. Cl. CPC H04L 1/1887; H04L 1/1822; H04W 56/0045

(57) ABSTRACT

A wireless terminal of a communications system comprises interface circuitry and processor circuitry. The interface circuitry is configured to receive, from a network node over a radio interface, a first configuration comprising an indication of a priority rule for resolving a collision between receiving at least one downlink channel/signal and transmitting at least one uplink channel/signal. The processor circuitry is configured to make determinations, including a first determination that the at least one downlink channel/signal and the at least one uplink channel/signal overlap by at least one symbol and a second determination whether to receive the at least one downlink channel/signal or transmit the at least one uplink channel/signal in accordance with the priority rule. The interface circuitry is further configured to receive the at least one downlink channel/signal or transmit the at least one uplink channel/signal in accordance with the second determination.

### TECHNICAL FIELD

The technology relates to wireless communications, and particularly to addressing, e.g., detecting, avoiding, and controlling collisions in a wireless communications system.

### BACKGROUND

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and NG-UTRAN, the New Radio (NR).

A radio access network may comprise one or more access nodes, such as base station nodes, which facilitate wireless communication or otherwise provides an interface between a wireless terminal and a communications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth-generation system, e.g., the 5G System, also called “NR” or “New Radio”, as well as “NG” or “Next Generation”, is shown in FIG. 1, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations (i.e. gNB & ng-eNB). A gNB node provides NR user plane and control plane protocol terminations towards the UE and is connected via the NG interface to the 5GC. The 5G NR (New Radio) gNB is connected to AMF (Access and Mobility Management Function) and UPF (User Plane Function) in 5GC (5G Core Network).

The Open Systems Interconnection, OSI, model is a reference framework that explains the process of transmitting data between computers. It is divided into seven layers that work together to carry out specialized network functions, allowing for a more systematic approach to networking. Information transferred from one device to another device travels through 7 layers of OSI model. First data travels down through 7 layers from the sender's end and then climbs back 7 layers on the receiver's end. Data flows through the OSI model in a step-by-step process:
Layer 7: Application Layer: Applications create the data.
Layer 6: Presentation Layer: Data is formatted and encrypted.
Layer 5: Session Layer: Connections are established and managed.
Layer 4: Transport Layer: Data is broken into segments for reliable delivery.
Layer 3: Network Layer: Segments are packaged into packets and routed.
Layer 2: Data Link Layer: Packets are framed and sent to the next device.
Layer 1: Physical Layer: Frames are converted into bits and transmitted physically.

A protocol stack may comprise different individual protocols. Protocols may be simply described as set of rules that allow communication between peer entities or they can also be described as set of rules that facilitate horizontal communication. These protocols may be arranged in the layers such as those described above. In a transmitter side, a layer N receives data from layer N+1 and this data is called the SDU or Service Data Unit. This layer will modify the data and convert it into a PDU or a Protocol Data Unit. The peer entity in the receiver is only able to understand this PDU. In the receiver side, the peer entity receives the PDU from layer N−1, e.g., actually layer N−1 SDU, and converts it back into SDU(s) and passes it to layer N+1.

Radio Link Control (RLC) is a layer 2 Radio Link Protocol used in UMTS, LTE and 5G on the Air interface. This protocol is specified by 3GPP in TS 25.322 for UMTS, TS 36.322 for LTE and TS 38.322 for 5G New Radio (NR). RLC is located on top of the 3GPP MAC-layer and below the PDCP-layer. The main tasks of the RLC protocol are:
Transfer of upper layer Protocol Data Units (PDUs) in one of three modes: Acknowledged Mode (AM), Unacknowledged Mode (UM) and Transparent Mode (TM)
Error correction through ARQ (only for AM data transfer)
Segmentation and reassembly of RLC SDUs (UM and AM)
Re-segmentation of RLC data PDUs (AM)
Reordering of RLC data PDUs (UM and AM)
Duplicate detection (UM and AM)
RLC SDU discard (UM and AM)
RLC re-establishment
Protocol error detection and recovery

The Radio Resource Control (RRC) plays a role in managing the radio resources between the User Equipment (UE) and the 5G New Radio (NR) network. The major functions of the RRC protocol include connection establishment and release functions, broadcast of system information, radio bearer establishment, reconfiguration and release, RRC connection mobility procedures, paging notification and release and outer loop power control. By means of the signaling functions the RRC configures the user and control planes according to the network status and allows for Radio Resource Management strategies to be implemented.

The Medium Access Control layer plays a role in managing radio resources and ensuring efficient communication within networks. It operates just above the physical layer (PHY) and below the radio link control (RLC) and the packet data convergence protocol (PDCP) layers. The medium access control (MAC) is the layer that controls the hardware responsible for interaction with the wired or wireless transmission medium. The MAC sublayer and the logical link control (LLC) sublayer together make up the data link layer. The LLC provides flw control and multiplexing for the logical link, while the MAC provides flow control and multiplexing for the transmission medium. These two sublayers together correspond to layer 2 of the OSI model. Functions performed by the MAC layer include the following:
Resource Allocation: The MAC layer allocates resources (e.g., time, frequency, and code resources) to connected user equipment (UEs) to facilitate efficient data transmission.
Scheduling: It determines which UEs can transmit data and when, taking into account various factors like Quality of Service (QoS) requirements, traffic types, and channel conditions.
HARQ (Hybrid Automatic Repeat reQuest): The MAC layer handles HARQ processes, enabling retransmissions of data packets in case of errors.
Logical Channels: It manages logical channels for control information exchange between the MAC layer and higher-layer protocols.
Multiplexing and De-Multiplexing: MAC layer multiplexes and de-multiplexes data flows from different UEs onto the shared radio resources.
PDCCH (Physical Downlink Control Channel): MAC plays a role in the allocation and signaling of PDCCH resources for control information transmission.
User Plane and Control Plane MAC Functions: MAC functions are divided into User Plane (UP) and Control Plane (CP) categories, each serving specific purposes. The UP MAC manages the transmission and reception of user data, while the CP MAC handles control signaling and coordination between the UE and the network.

Thus, functions performed by the MAC layer include:
Frame delimiting and recognition
Addressing of destination stations (both as individual stations and as groups of stations)
Conveyance of source-station addressing information
Transparent data transfer of LLC PDUs, or of equivalent information in the Ethernet sublayer
Protection against errors, generally by means of generating and checking frame check sequences
Control of access to the physical transmission medium

A RRC is in control of the MAC configuration. A MAC entity of a wireless terminal serves many functions, including handling the following transport channels:
Broadcast Channel (BCH)
Downlink Shared Channel(s) (DL-SCH)
Paging Channel (PCH)
Uplink Shared Channel(s) (UL-SCH)
Random Access Channel(s) (RACH).

The access stratum, AS, is a functional layer in protocol stacks between a radio network and user equipment. The access stratum is responsible, e.g., for transporting data over the wireless connection and managing radio resources.

Reduced capability (RedCap) UEs, e.g., wireless terminals, are designed to address use cases that require moderate performance, but lower complexity and cost compared to legacy UEs. RedCap was introduced in 3GRPP Rel-17 to support applications such as wearables, industrial sensors, and smart IoT devices.

Key features of RedCap UEs include reduced complexity, e.g., lower number of antennas, smaller bandwidth, HD-FDD, lower data rates, power efficiency, and cost effectiveness while supporting key 5G NR features (e.g., FR1/FR2, eMBB, URLLC). Use cases include health and fitness wearables, smart city devices, industrial IoT, and logistics tracking.

The non-terrestrial network, NTN, Rel-19 Work Item objectives were updated, e.g., as shown in Table 1, to include enhancements of collisions cases 3 and 4 for half duplex frequency division duplex, HD-FDD, UEs. Collision case 4 refers to dynamically scheduled DL reception colliding with dynamically scheduled UL transmission,” i.e., a DL-UL overlap in time.

TABLE 1
5. Support of Rel-17 RedCap and Rel-18 eRedCap UEs with NR NTN operating in FR1-
NTN bands [RAN4, RAN1]

| • | For full-duplex and half duplex FDD RedCap and eRedCap UEs, define the RF and | |
|---|---|---|
| | RRM requirements [RAN4] | |
| • | For HD-FDD RedCap UEs and eRedCap UEs, specify enhancements for mitigating | |
| | issues caused by TA mismatch between actual TA used by the UE and assumed TA | |
| | for the UE at the gNB [RAN1] | |
| | ∘ | Enhancements are targeted for the following HD collisions cases (cases 3 and |
| | | 4): |

| | |
|---|---|
| ▪ | Semi-statically configured DL reception collides with semi- |
| | statically configured UL transmission |
| ▪ | Dynamically scheduled DL reception collides with dynamic |
| | scheduled UL transmission |

| | ∘ | Note: enhancements for other HD collision cases are not targeted. |
|---|---|---|
| | | Enhancements for HD collision cases 3 and 4 that may improve other HD |
| | | collision cases are not precluded. |
| | ∘ | Note: potential work in RAN2, if any, starts after RAN1 has decided on the |
| | | solution. |
| • | Notes for this objective: | |
| | ∘ | GNSS (Global Navigation Satellite Systems) capabilities and simultaneous |
| | | GNSS and NR-NTN operation is supported in RedCap/eRedCap UE. |

As specified in the 3FPP technical specifications TS 38.213 and TS 38.331, timing advance (TA) in 5G NR is a mechanism devised to align uplink signals from multiple UEs at the base station despite varying propagation delays of the said uplink signals that are caused by varying distances between the UEs and the base station. The base station may calculate the required TA for each UE based on uplink reference signals (e.g., SRS or PRACH preambles) from the UE, and sends TA commands to the UE to adjust its uplink transmission timing accordingly. In general, TA needs to be updated dynamically to maintain the timing alignment as the UE moves.

In the case of NTN, particularly with LEO satellites, the base station, or the wireless node onboard the satellite that relays the signals between the base station and UEs, also moves, which causes additional variations in the TA. In the case of HD-FDD UEs, for example reduced capability (RedCap) UEs connected to an NTN, this phenomenon may lead to variations of the TA at a rate that exceeds the rate at which the base station can track the value of the TA. As a result, a UE may not be updated with sufficiently frequent TA commands, which may lead to a TA mismatch, which refers to a difference between the required TA, proportional to the instantaneous propagation delay between the UE and the base station, and the latest TA value indicated by a TA command from the base station. If the TA mismatch is not taken into account for scheduling, it may lead to a time overlap between a DL reception and a UL transmission at the UE, which is referred to as a DL-UL collision.

It has been stated that the timing advance, TA, mismatch between UE and gNB can be as large as +/−16 ms with the least frequent report triggering, and up to +/−1.5 ms with the most frequent report triggering. For a UE incapable of TA reporting or not configured with TA reporting, the TA mismatch can be as large as the difference between the maximum and minimum TA in the cell coverage area. Additionally, even with the smallest value of the triggering offset threshold (0.5 ms), the legacy TAR scheme with 1 ms granularity renders substantially limited resources for scheduling UL.

Table 2 includes text from From TS 38.213 v18.4.0 Section 17.2.

TABLE 2
17.2 Half-Duplex UE in paired spectrum
A half-duplex UE (HD-UE) in paired spectrum is not capable of simultaneous transmissions
and receptions on a serving cell with paired spectrum. This clause is applicable for
communication of a HD-UE on a serving cell with paired spectrum. Procedures for a HD-
UE are same as described for a UE in all other clauses of this document unless stated
otherwise.
A HD-UE does not expect to detect a DCI format scheduling a reception in a set of symbols
and detect a DCI format scheduling a transmission in any symbol from the set of symbols.
When a PDCCH reception by a UE includes two PDCCH candidates from corresponding
search space sets, as described in clause 10.1, the end of the PDCCH reception is the end of
the PDCCH candidate that ends later.
If a HD-UE is configured by higher layers to receive a PDCCH, or PDSCH, or CSI-RS, or
DL PRS in a set of symbols, the HD-UE receives the PDCCH, or PDSCH, or CSI-RS, or DL
PRS if the HD-UE does not detect a DCI format that indicates to the HD-UE to transmit a
PUSCH, or PUCCH, or PRACH, or SRS in at least one symbol of the set of symbols;
otherwise, the HD-UE does not receive the PDCCH, or PDSCH, or CSI-RS, or DL PRS in
the set of symbols.
If a HD-UE is configured by higher layers to transmit SRS, or PUCCH, or PUSCH in a set
of symbols and the UE detects a DCI format indicating to the HD-UE to receive CSI-RS or
PDSCH in a subset of symbols from the set of symbols, then

| | |
|---|---|
| - | the HD-UE does not expect to cancel the transmission of the PUCCH or PUSCH in the |
| | set of symbols if the first symbol in the set occurs within T_{proc,2} relative to a last |
| | symbol of a PDCCH reception where the HD-UE detects the DCI format; otherwise, |
| | the HD-UE cancels the PUCCH, or the PUSCH, or an actual repetition of the PUSCH |
| | [6, TS 38.214], determined from clauses 9 and 9.2.5 or clause 6.1 of [6, TS 38.214]. |
| - | the HD-UE does not expect to cancel the transmission of SRS in symbols from the |
| | subset of symbols that occur within T_{proc,2} relative to a last symbol of a PDCCH |
| | reception where the HD-UE detects the DCI format. The HD-UE cancels the SRS |
| | transmission in remaining symbols from the subset of symbols. |
| | T_{proc,2} is the PUSCH preparation time for UE processing capability 1 [6, TS 38.214] |
| | assuming d_{2,1} = 1 and μ corresponds to the smallest SCS configuration between the |
| | SCS configuration of the PDCCH carrying the DCI format and the SCS configuration |
| | of the SRS, PUCCH, PUSCH. |

A HD-UE does not expect to receive both dedicated higher layer parameters configuring
transmission in a set of symbols and dedicated higher layer parameters configuring reception
in the set of symbols. A HD-UE does not expect to receive both a Type-0/0A/0B/1/2-
PDCCH CSS set configuration for PDCCH reception in a set of symbols and dedicated
higher layer parameters configuring transmission in the set of symbols, except a Type-2-
PDCCH CSS set configuration for PDCCH reception in a set of symbols and dedicated
higher layer parameters configuring configured-grant based PUSCH transmission as
described in clause 19.1 in the set of symbols for which case the UE follows the procedure
as in clause 5.1B.2.6 in [10, TS 38.133]. The UE expects to be configured with a Type-2-
PDCCH CSS set configuration for PDCCH reception such that there is at least one paging
occasion that does not overlap with configured-grant based PUSCH transmission as
described in clause 19.1 per SI modification period.
If a HD-UE would transmit a PUSCH, or PUCCH, or SRS based on a configuration by
higher layers and the HD-UE is indicated presence of SS/PBCH blocks within the active DL
BWP by ssb-PositionsInBurst in SIB1 or in ServingCellConfigCommon or by
NonCellDefiningSSB, the HD-UE does not transmit

| | |
|---|---|
| - | PUSCH or PUCCH if a last symbol of the PUSCH or PUCCH transmission would not |
| | be at least N_{Tx-Rx} · T_{c} [4, TS 38.211] prior to a first symbol of the next earliest |
| | SS/PBCH block |
| - | PUSCH or PUCCH if a first symbol of the PUSCH or PUCCH transmission would not |
| | be at least N_{Rx-Tx} · T_{c} [4, TS 38.211] after a last symbol of the previous latest SS/PBCH |
| | block |
| - | SRS in symbols that would not be at least N_{Tx-Rx} · T_{c} prior to a first symbol of the next |
| | earliest SS/PBCH block |
| - | SRS in symbols that would not be at least N_{Rx-Tx} · T_{c} after a last symbol of the previous |
| | latest SS/PBCH block |

If a HD-UE would transmit a PRACH based on a detected DCI format, or PUSCH, or
PUCCH, or SRS and the HD-UE is indicated presence of SS/PBCH blocks within the active
DL BWP by ssb-PositionsInBurst in SIB1 or in ServingCellConfigCommon or by
NonCellDefiningSSB in a set of symbols, the HD-UE does not transmit PUSCH or PUCCH
or PRACH if a transmission would overlap with any symbol from the set of symbols and the
HD-UE does not transmit SRS in the set of symbols.
If a HD-UE would transmit a PRACH or MsgA PUSCH triggered by higher layers in a set
of symbols and would receive a PDCCH, or a PDSCH, or a CSI-RS, or a DL PRS, or is
indicated presence of SS/PBCH blocks within the active DL BWP by ssb-PositionsInBurst
in SIB1 or in ServingCellConfigCommon or by NonCellDefiningSSB in symbols that include
any symbol from the set of symbols, the HD-UE can select based on its implementation
whether to either transmit the PRACH or the MsgA PUSCH or receive the PDSCH, or the
CSI-RS, or the PL RS, or the PDCCH, or the SS/PBCH blocks.
If a HD-UE would receive a PDCCH, or a PDSCH, or a CSI-RS, or a DL PRS based on a
configuration by higher layers or is indicated presence of SS/PBCH blocks within the active
DL BWP by ssb-PositionsInBurst in SIB1 or in ServingCellConfigCommon or by
NonCellDefiningSSB in a set of symbols, and the HD-UE would transmit PRACH or MsgA
PUSCH triggered by higher layers starting or ending at a symbol that is earlier or later than
N_{Rx-Tx} · T_{c} or N_{Tx-Rx} · T_{c}, respectively, from the last or first symbol in the set of symbols, the
HD-UE can select based on its implementation whether to either transmit the PRACH or the
MsgA PUSCH or receive the PDSCH, or the CSI-RS, or the DL PRS, or the PDCCH, or the
SS/PBCH blocks.

What is needed are methods, apparatus, and/or techniques to address uplink and downlink collisions in a wireless network.

### SUMMARY

In a first of its example aspects the technology disclosed herein concerns a wireless terminal of a communications system which comprises interface circuitry and processor circuitry. The interface circuitry is configured to receive, from a network node over a radio interface, a first configuration comprising an indication of a priority rule for resolving a collision between receiving at least one downlink channel/signal and transmitting at least one uplink channel/signal. The processor circuitry is configured to make determinations, including a first determination that the at least one downlink channel/signal and the at least one uplink channel/signal overlap by at least one symbol and a second determination whether to receive the at least one downlink channel/signal or transmit the at least one uplink channel/signal in accordance with the priority rule. The interface circuitry is further configured to receive the at least one downlink channel/signal or transmit the at least one uplink channel/signal in accordance with the second determination. Methods of operating such wireless terminals are also provided.

In another of its example aspects the technology disclosed herein concerns a network node of a telecommunications system which comprises processor circuitry and transmitter circuitry. The processor circuitry is configured to generate a collision priority rule configuration message. The transmitter circuitry is configured to transmit the collision priority rule configuration message over a radio interface to a wireless terminal. In various example embodiments and modes, the priority rule of the collision priority rule configuration message may be based, at least in part, on at least one of: whether the downlink channel/signal or the uplink channel/signal is a first transmission or a retransmission; whether the uplink channel/signal is configured with a repetition; a retransmission number of the downlink channel/signal or the uplink channel/signal; and a redundancy version of the downlink channel/signal or the uplink channel/signal. Methods of operating such network nodes are also disclosed.

In another example aspect the technology disclosed herein concerns a wireless terminal of a communications system. In an example embodiment and mode, the wireless terminal comprises interface circuitry and at least one processor. The interface circuitry is configured to receive, from a network node over a radio interface, a latest decoded timing advance, TA, command. The at least one processor is configured to make a determination that an uplink transmission according to the latest decoded timing advance, TA, command would or could result in a timing advance mismatch and/or a downlink-uplink collision on the radio interface, and to generate a timing advance, TA, report message as a result of the determination. The interface circuitry is configured to transmit the timing advance, TA, report message to the network node over the radio interface. Methods of operating such wireless terminals are also provided.

In another of its example aspects the technology disclosed herein concerns a network node of a communications system which comprises at least one processor and interface circuitry. The at least one processor is configured to generate a network-determined latest timing advance command. The interface circuitry is configured to transmit the latest timing advance command over a radio interface to a wireless terminal; and to receive a timing advance, TA, report message from the wireless terminal over the radio interface, the timing advance, TA, report message comprising an indication of a timing advance mismatch and/or a downlink-uplink collision on the radio interface. Methods of operating such network nodes are also disclosed.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view of an exemplary embodiment and mode of a generic communications system wherein a wireless terminal prioritizes uplink and downlink channels/signal according to a generic example embodiment and mode.

FIG. 3 is a flowchart illustrating example, generic acts or steps performed by a network node of the example embodiment and mode of FIG. 2.

FIG. 4 is a flowchart illustrating example, generic acts or steps performed by a wireless terminal of the example embodiment and mode of FIG. 2.

FIG. 5A-FIG. 5G are diagrammatic views of exemplary embodiments and modes of a communications system wherein a wireless terminal prioritizes uplink and downlink channels/signal according to other example embodiments and modes.

FIG. 6 is a diagrammatic view showing, in more but non-exhaustive, non-limiting detail, other example functionalities and units for one or more of the example embodiments and modes of FIG. 5A-FIG. 5G.

FIG. 7 is a diagrammatic view of other exemplary embodiments and modes wherein a wireless terminal determines a timing advance mismatch and/or a collision condition and generates a timing advance report upon determination of the collision condition.

FIG. 8 is diagrammatic view depicting example, representative, generic acts or steps which may be performed by the example embodiments and modes of FIG. 7.

FIG. 9 is a diagrammatic view of a first example format for a timing advance report generator of the example embodiments and modes of FIG. 7.

FIG. 10 is a diagrammatic view of a second example format for a timing advance report generator of the example embodiments and modes of FIG. 7.

FIG. 11 is a diagrammatic view of exemplary embodiments and modes wherein a wireless terminal generates and transmits a collision report or collision indication.

FIG. 12 is a diagrammatic view of an example format for a collision report or collision indication generated by the example embodiment and mode of FIG. 12.

FIG. 13 is a diagrammatic view of exemplary embodiments and modes wherein a wireless terminal generates and transmits an indication that a PDSCH was not received due to timing advance mismatch.

FIG. 14 is diagrammatic view depicting example, representative, generic acts or steps or signals which may be performed and/or generated by the example embodiments and modes of FIG. 13.

FIG. 15 is a diagrammatic view of exemplary embodiments and modes wherein a wireless terminal determines what repetitions of the PUSCH are permitted to be transmitted to a network.

FIG. 16 is diagrammatic view depicting example, representative, generic acts or steps or signals which may be performed and/or generated by the example embodiments and modes of FIG. 15.

FIG. 17 is a diagrammatic view showing example elements comprising electronic machinery which may comprise a wireless terminal, a radio access node, and a core network node according to an example embodiment and mode.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”); IMT-2020, e.g., 5G; IMT-2030, e.g., 6G, etc. All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

A core network (CN) may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. A core network may communicate over a RAN-CN interface (e.g., N2 interface) with one or more radio access networks (RAN).

A radio access network (RAN) may communicate with one or more core networks. A radio access network (RAN) typically comprises plural access nodes. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

A radio access network (RAN) serves wireless terminals, which also form part of the radio access network (RAN). As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. In some non-limiting example embodiments and modes the wireless terminal node may operate in a half-duplex frequency-division duplexing mode.

A wireless terminal communicates with its serving radio access network (RAN) over a radio or air interface. Communication between radio access network (RAN) and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

Communication between radio access network (RAN) 24 and wireless terminal over the radio interface 32 may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”. Reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two-dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix

In 5G New Radio (“NR”), a frame consists of 10 ms duration. A frame consists of 10 subframes with each having 1 ms duration similar to LTE. Each subframe consists of 2u slots. Each slot can have either 14 (normal CP) or 12 (extended CP) OFDM symbols. A Slot is a typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slots help to achieve lower latency in 5G NR architecture. Unlike slots, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

In general, communication protocols between the wireless terminal and the telecommunication system may be categorized into Access Stratum (AS) and Non-Access Stratum (NAS). AS protocols, such as Radio Resource Control (RRC) and Medium Access Control (MAC), may be used for the wireless terminal to communicate with access nodes of a RAN, whereas NAS protocol(s), such as the NAS protocol specified in 3GPP TS 24.501, may be used for the wireless terminal to communicate with entities (e.g., AMF) of a CN(s), via access nodes of a RAN. Consequently, the wireless terminal may comprise a function to manage the AS protocols, and a separate function to manage the NAS protocol(s). Herein, terminology “NAS” may be used in some context to refer to the function built into the wireless terminal to manage the NAS protocol(s). Similarly, “RRC” may be used in some context to refer to the function built into the wireless terminal to manage the RRC protocol.

Logical channels reside between the RLC sublayer and the MAC sublayer which, as already mentioned, are layer 2 protocols in protocol stack. A Logical channel informs what kind of information is transferred. Logical channels can be broadly divided into two types:

Control Channels (for the transfer of control plane information) and Traffic Channels (for the transfer of user plane information). A logical channel is eventually mapped to a physical channel.

The technology disclosed herein generally concerns and addresses collisions, both actual collisions and anticipated collisions, between uplink and downlink transmission in a wireless communication system. As used herein, a “collision” may be an actually occurring/occurred collision or an anticipated collision. An actual collision is a collision that has already occurred; an anticipated collision: has not occurred, but the wireless terminal has received DL and UL schedules that are about to collide. A TA mismatch that may lead to a collision, i.e., the TA mismatch exists, but the UE has not yet received DL and UL schedules that collide

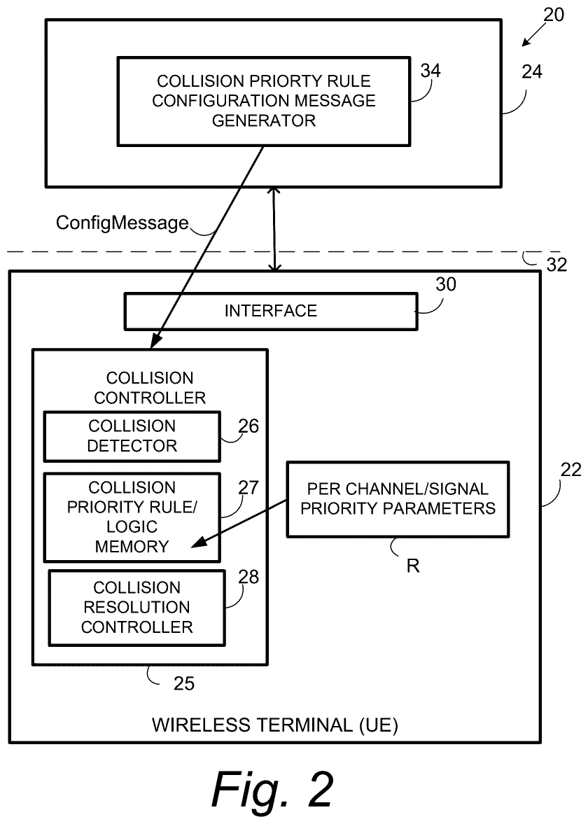

Various example embodiments and modes pertain, in non-limiting manner, to avoidance and/or control of such collisions. The systems and methods disclosed herein may be beneficial for non-terrestrial networks but are not limited thereto nor to the previously discussed collision case 4. Various collision problems have been currently identified for NTN, generally because the movement of the LEO satellite can cause a timing advance mismatch. However, the systems and methods disclosed herein including all example embodiments and modes hereof are not limited to NTN but can also be used to address a DL-UL collision that may occur due to other causes. Thus, the systems and methods disclosed herein may generally apply to any DL-UL collision in 5G and forthcoming versions such as 6G and other future releases, particularly in 6G. The encompassed example embodiments and modes may be generically represented by the example communications system 20 of FIG. 2 and the example method acts illustrated herein.

FIG. 2 shows a communications system 20 comprising wireless terminal 22 and network node 24. The network node 24 may be any suitable node, such as a node of a radio access network, or a node of a core network, for example. The network node 24 may also be employed in a non-terrestrial network, in which case non-limiting examples of network node 24 may include a non-terrestrial node; a node carried onboard a non-terrestrial vehicle; a satellite; and/or an uncrewed aerial vehicle. In some non-limiting example embodiments and modes the network node may operate in a half-duplex frequency-division duplexing mode.

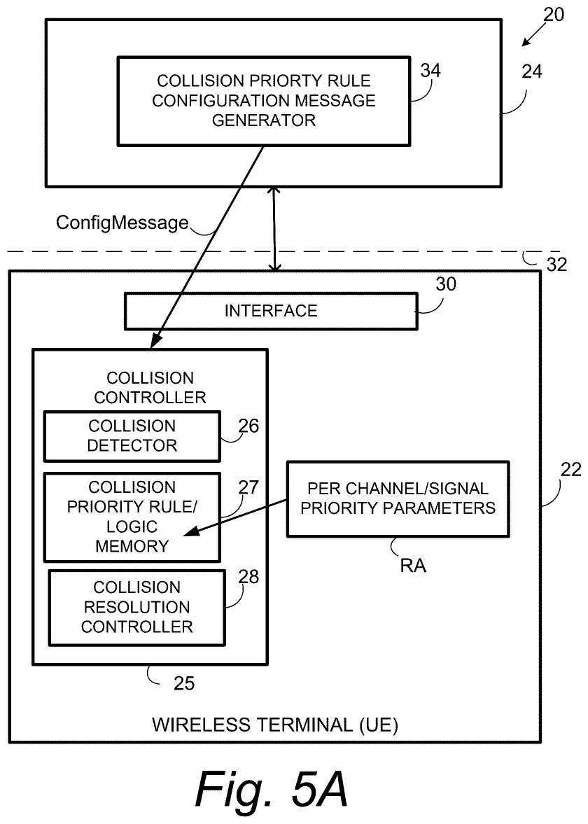

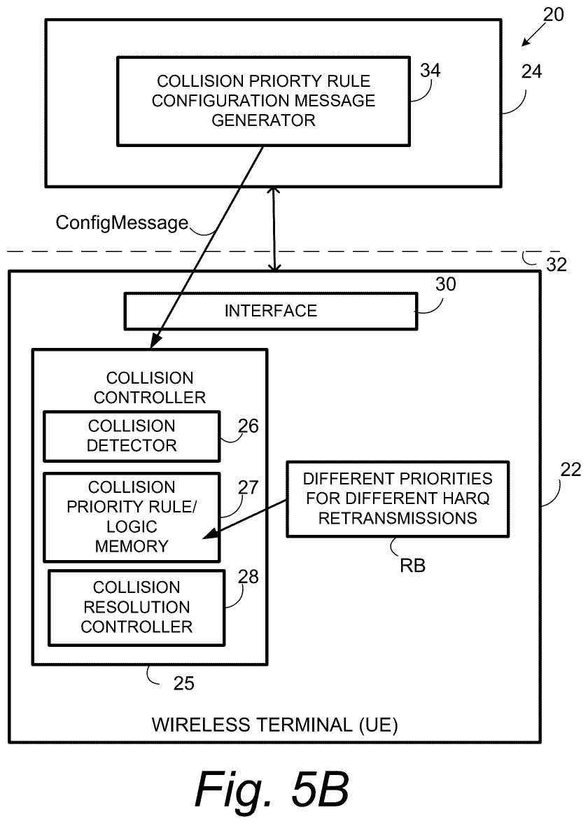

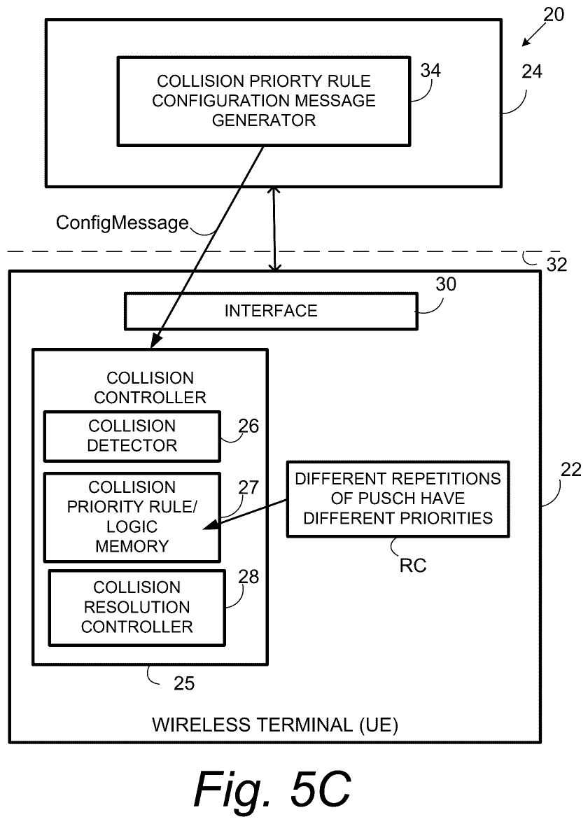

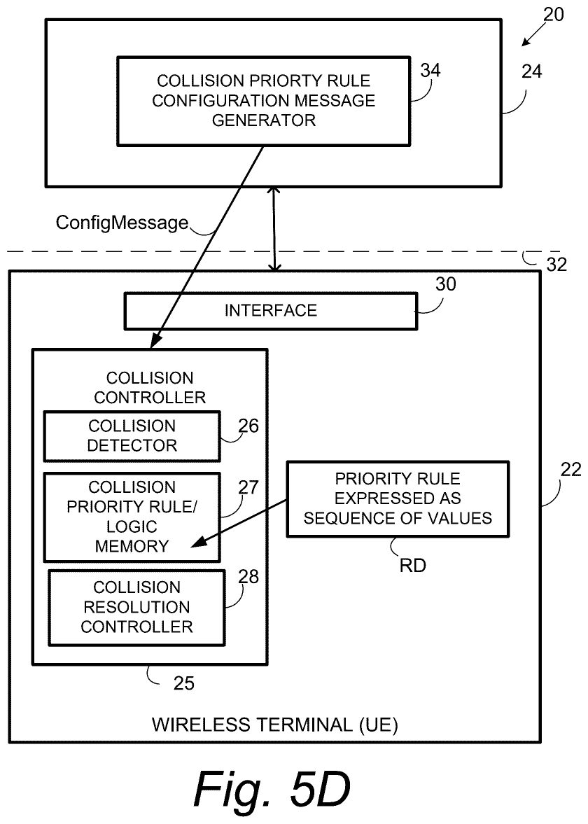

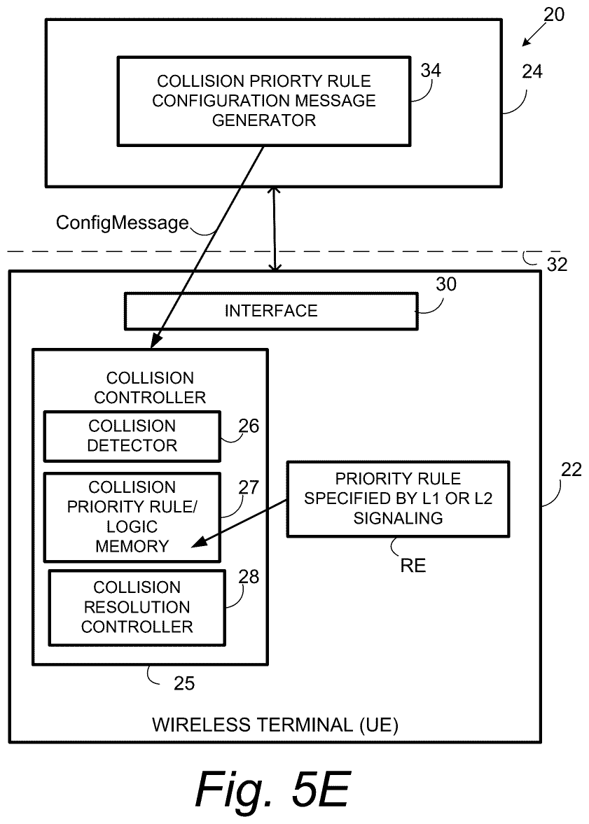

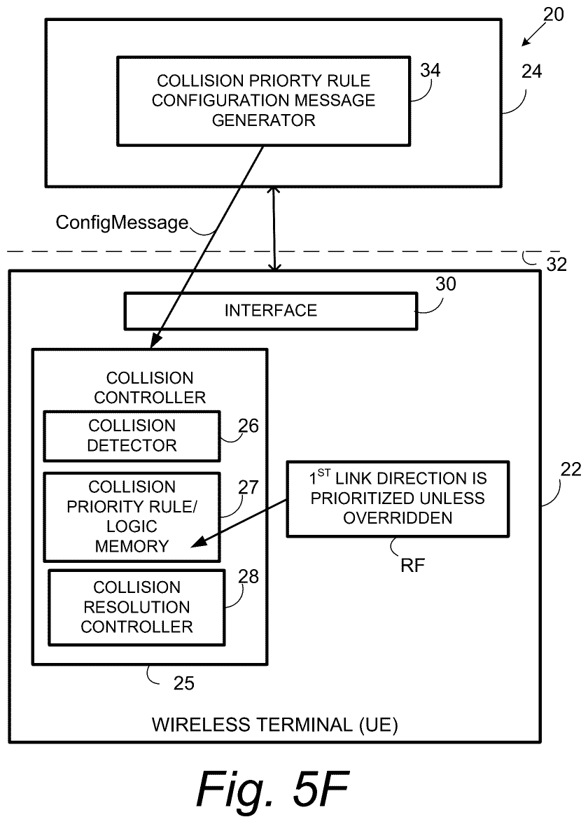

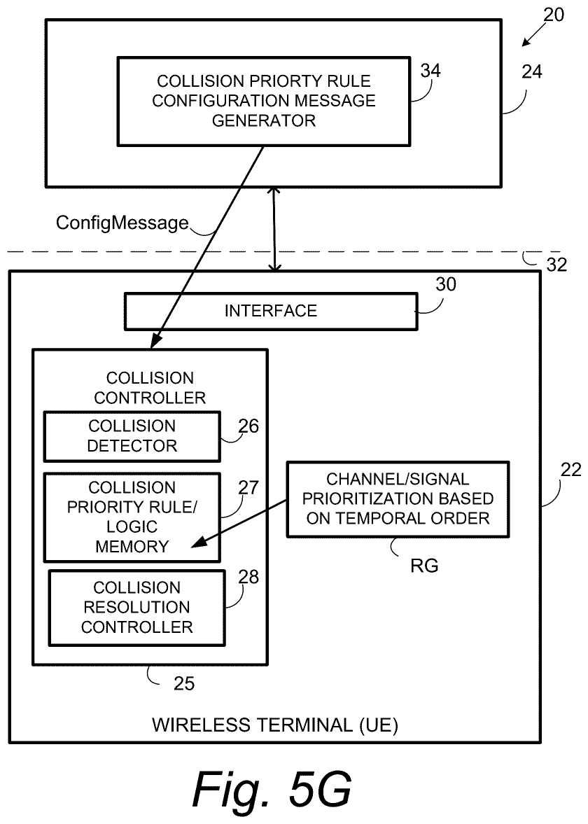

The network node 24 comprises, e.g., collision priority rule configuration message generator 34. The collision priority rule generated by generator 34 may also be referred to as a first configuration, and as such may comprise an indication of a priority rule for resolving a collision between receiving at least one downlink channel/signal and transmitting at least one uplink channel/signal. Examples of the collision priority rules which may be generated by generator 34 are described below, e.g., with reference of FIG. 5A-FIG. 5G, for example.

The wireless terminal 22 comprises collision controller 25. As further shown in FIG. 2, the collision controller 25 comprises collision detector 26; collision priority rule/logic memory 27; and priority controller 28, which may also be known as transmitter/receiver priority controller 28 or collision resolution controller 28.

The collision detector 26 is configured and serves to make a determination, herein referred to as a “first determination”, that at least one downlink channel/signal and the at least one uplink channel/signal are in collision, e.g., at least one downlink channel/signal and the at least one uplink channel/signal overlap by at least one symbol.

The priority controller 28 is configured and serves to make a determination, herein also referred to as a second determination, whether to receive the at least one downlink channel/signal or transmit the at least one uplink channel/signal in accordance with the priority rule and/or logic that is stored in collision priority rule/logic memory 27.

FIG. 2 further shows, in a fashion represented by a rectangle block “R”, either the rule “R” which is received in collision priority rule configuration message, or logic which is implemented by collision controller 25, e.g., by priority controller 28, in making the second determination.

FIG. 2 further shows that wireless terminal 22 also comprises interface circuitry 30, and that wireless terminal 22 network node 24 communicate with each other on both a downlink and an uplink over radio or air interface 32. As used herein, in terms of transmission direction, “downlink” refers to a direction over radio or air interface 32 from a network, e.g., from network node 24, to the wireless terminal 22.

The wireless terminal 22 and network node 24 of FIG. 2 may operate in accordance with one or more of the example embodiments and modes hereof. Further, the wireless terminal 22 and network node 24 of FIG. 5A may selectively switch between the various modes described herein and may combine one or more features from two or more of the various modes.

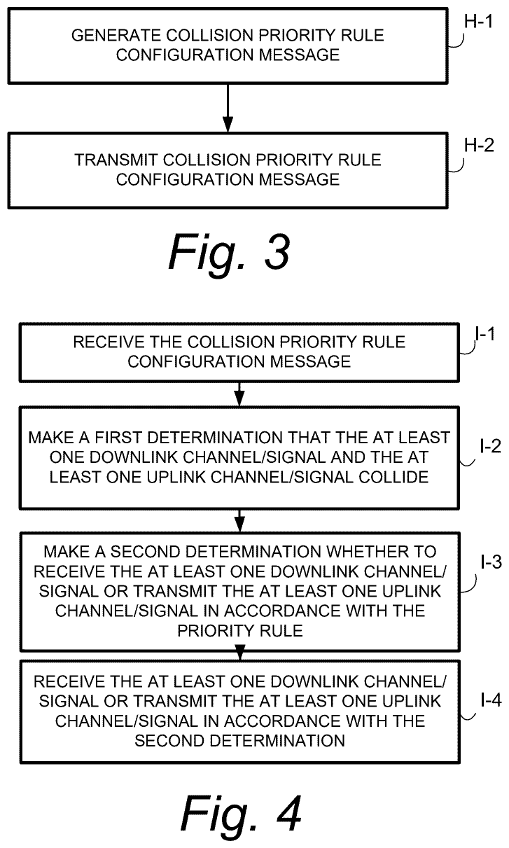

FIG. 3 shows example, generic, representative acts or steps that may be performed by network node 24 in accordance with the generic example embodiment and mode of FIG. 2 as well as in the other example embodiments and modes of FIG. 5A-FIG. 5G. Act 3-1 comprises the network node 24, e.g., collision priority rule configuration message generator 34, generating the collision priority rule configuration message. The collision priority rule configuration message may take various forms, examples of which are illustrated further herein. Act 3-2 comprises network node 24 transmitting the collision priority rule configuration message over the radio or air interface 32 to wireless terminal 22. Transmission of the collision priority rule configuration message, e.g., the collision priority rule configuration message itself, is indicated by an arrow labeled “ConfigMessage” in each of FIG. 2 and FIG. 5A-FIG. 5G.

FIG. 4 shows example, generic, representative acts or steps that may be performed by wireless terminal 22 in accordance with the generic example embodiment and mode of FIG. 2 as well as in the other example embodiments and modes of FIG. 5A-FIG. 5G. Act 4-1 comprises the wireless terminal 22, e.g., interface circuitry 30, receiving the collision priority rule configuration message which was transmitted as act 3-2.

Act 4-2 comprises the wireless terminal 22, e.g., collision detector 26, making the first determination that at least one downlink channel/signal and the at least one uplink channel/signal are in collision, e.g., at least one downlink channel/signal and the at least one uplink channel/signal overlap by at least one symbol.

Act 4-3 comprises the wireless terminal 22, e.g., priority controller 28, making the second determination whether to receive the at least one downlink channel/signal or transmit the at least one uplink channel/signal in accordance with the priority rule.

Act 4-4 comprises the wireless terminal 22, e.g., interface circuitry 30 under control of priority controller 28, either receiving the at least one downlink channel/signal or transmitting the at least one uplink channel/signal in accordance with the second determination.

Various more detailed example embodiments and modes of are below described, e.g., with reference to FIG. 5A-FIG. 5G. The different example embodiments and modes described, e.g., in FIG. 5A-FIG. 5G, make use of a priority rule or priority logic that may differ for each embodiment, with the priority rule being suffixed as one of rule RA through rule RX in accordance with the corresponding example embodiment and mode.

### 1.0 Network-Provided Priority Rules

In some example embodiments and modes, the 22 is configured with rules for prioritizing a channel or signal when a dynamically scheduled DL collides with a dynamically scheduled UL due to a timing adjustment, TA, mismatch, which is currently referred to in RAN1 discussions as collision case 4. The rules may be expressed in the collision priority rule configuration message of which message ConfigMessage of FIG. 2 is an example.

### 1A: Network-Provided Per Channel/Signal Priority Parameters

In an example embodiment and mode illustrated in FIG. 5A, the 22 is configured with an RRC IE comprising a plurality of priority parameters, each associated with a type of dynamically scheduled channel or signal. Then, if two channels or signals collide, the UE transmits the channel or signal with a smaller (or larger resp.) value for its associated priority parameter. FIG. 5A shows that collision detector 26 of wireless terminal 22 is provided with rule RA, a priority rule comprises per channel/signal priority parameters.

Listing 1 is an example of ASN.1 code for an example RRC IE for FIG. 5A.

Listing 1

DL-UL-Collision-Priority ::= SEQUENCE {

| | |
|---|---|
| dynamicPDSCH-Priority | PriorityValue OPTIONAL, |
| dynamicCSI-RS-Priority | PriorityValue OPTIONAL, |
| dynamicPUSCH-Priority | PriorityValue OPTIONAL, |
| aperiodicPUCCCH-Priority | PriorityValue OPTIONAL, |
| dynamicPRACH-Priority | PriorityValue OPTIONAL, |
| aperiodic-SRS-Priority | PriorityValue OPTIONAL, |

...
}
PriorityValue ::= INTEGER (0..maxPriorityValue)

As used herein, the priority values do not have to be unique-two channels or signals may be assigned similar priority values. In that case, several options may be considered.

The example embodiments and modes of FIG. 5A include various options. For example, in Option 1: If two channels or signals with equal priority values collide, it is up to the UE (implementation) to decide which channel or signal to prioritize. In Option 2: If two channels or signals with equal priority values collide, the UE follows other priority rules specified by the standard and/or indicated by the network, implicitly or explicitly, to determine which channel or signal to prioritize.

If a channel or signal is not assigned a priority value, the channel or signal may be assigned a default priority value, a highest priority value, or a lowest priority value. A default priority value may be indicated in the manner of Listing 2 as follows:

Listing 2

```
DL-UL-Collision-Priority ::= SEQUENCE {
  ...
  default-Priority PriorityValue OPTIONAL
}
```

### 1B: Different Transmissions Assigned Different Priority Values

In the example embodiments and modes of Eig. EB, different retransmissions of a transport block, TB, in a hybrid automatic repeat request, HARQ, process may be assigned different priority values. Listing 3 is an example of ASN.1 code for an example RRC IE for the example embodiments and modes of FIG. 5B.

Listing 3

```
DL-UL-Collision-Priority ::= SEQUENCE {
  ...
  dynamicPDSCH-RV0-Priority PriorityValue OPTIONAL,
  dynamicPDSCH-RV1-Priority PriorityValue OPTIONAL,
  dynamicPDSCH-RV2-Priority PriorityValue OPTIONAL,
  dynamicPDSCH-RV3-Priority PriorityValue OPTIONAL,
  ...
  dynamicPUSCH-RV0-Priority PriorityValue OPTIONAL,
  dynamicPUSCH-RV1-Priority PriorityValue OPTIONAL,
  dynamicPUSCH-RV2-Priority PriorityValue OPTIONAL,
  dynamicPUSCH-RV3-Priority PriorityValue OPTIONAL,
  ...
}
```

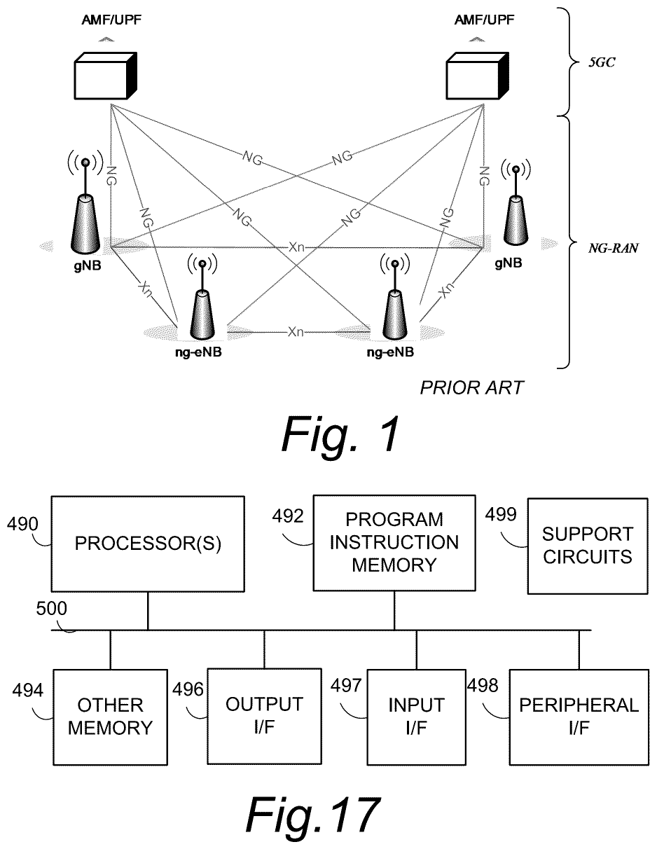

The example embodiments and modes of FIG. 1B allow the network to prioritize later retransmissions of a TB to avoid triggering a failure event at a higher layer.

In alternative realizations, a first reception of a PDSCH or a first transmission of a PUSCH may be prioritized, while later receptions or transmissions are deprioritized. Conversely, a first reception of a PDSCH or a first transmission of a PUSCH may be deprioritized, while later receptions or transmissions are prioritized in order to avoid triggering a failure event at a higher layer.

### 1C: Different Repetitions of Pusch Assigned Different Priority Values

Similarly, in the example embodiments and modes of FIG. 5C, different repetitions of a PUSCH may be assigned different priority values. Listing 4 is an example of ASN.1 code for an example the RRC IE for the example embodiments and modes of FIG. 5C.

Listing 4

```
DL-UL-Collision-Priority ::= SEQUENCE {
  ...
  dynamicPUSCH-Rep0-Priority PriorityValue OPTIONAL,
  dynamicPUSCH-Rep1-Priority PriorityValue OPTIONAL,
  dynamicPUSCH-Rep2-Priority PriorityValue OPTIONAL,
  dynamicPUSCH-Rep3-Priority PriorityValue OPTIONAL,
  ...
}
```

In an alternative realization for the example embodiments and modes of FIG. 5C, a PUSCH type may be used to determine a priority for transmitting the PUSCH. For example, if a PUSCH is configured with repetition, one or multiple of the repetitions may be given a lower priority as other repetitions of the PUSCH may have a chance for transmission. In this case, the UE may be required to make sure that at least one repetition or at least M out of N repetitions are transmitted.

Conversely, a PUSCH with repetition may be considered a higher priority channel because the network may not be able to decode the PUSCH properly if some repetitions are not transmitted, which can result in resource wastage.

Any of these realizations may be specified by the standard, configured/indicated by the network, or applied according to a UE implementation.

### 1D: Different Priority Rules Indicated by Ordered Sequences

In the example embodiments and modes illustrated by FIG. 5D, priority rules are indicated as a sequence of tuples (DL-type, UL-type, priority). For example, the priority rules are indicated as a sequence of priority values in correspondence with different signals/channels. In the example embodiments and modes of FIG. 5D, the network indicates for each pair of possible DL-UL types which one has priority: DL or UL. For example, between PDSCH and PUSCH, the network may indicate to prioritize the former (DL), but between PDSCH and SRS the network may indicate to prioritize the latter (UL). Each tuple (DL type, UL type, priority) may indicate one rule. In general, the ordering of the indicated tuples may not matter. A non-limiting example is shown in Listing 5.

Listing 5

DL-UL-Collision-Priority ::= SEQUENCE {
...

| | |
|---|---|
| priorityRules | SEQUENCE (SIZE (1..maxNrofPriorityRules)) OF PriorityRule, |

...
}
PriorityRule ::= SEQUENCE {

| | |
|---|---|
| dl-Type | ENUMERATED { dl-Type-PDSCH, dl-Type-CSI-RS, dl-Type-PDSCH-RV0, |

dl-Type-PDSCH-RV1, ... },

| | |
|---|---|
| ul-Type | ENUMERATED { ul-Type-PUSCH, ul-Type-PUCCH, dl-Type-PRACH, ul- |

Type-SRS, ul-Type-PUSCH-RV0, ul-Type-PUSCH-RV1, ..., ul-Type-PUSCH-Rep0, ul-Type-
PUSCH-Rep1, ... },

| | |
|---|---|
| priority | ENUMERATED {rxDL, txUL} |

}

If a priority rule is not assigned to a pair of channel/signal types, the UE may follow a default rule to prioritize DL or UL. A default priority rule may be configured as shown by way of non-limiting example in Listing 6

Listing 6

```
DL-UL-Collision-Priority ::= SEQUENCE {
  ...
  default-Priority ENUMERATED {rxDL, txUL} OPTIONAL
}
```

In some example realizations and implementations, if a retransmission or repetition is not assigned a priority rule, the UE follows the closest retransmission or repetition that is assigned a priority rule. For example, if PDSCH Tx1 is assigned priority ‘txUL’ and PDSCH Tx1 is assigned priority ‘rxDL’, then PDSCH Tx0 may be assumed to be assigned priority ‘txUL’ and PDSCH Tx2 may be assumed to be assigned priority ‘rxUL’.

### 1E: Different Priority Rules Indicated by Lower Layer Signaling

In the example embodiments and modes of FIG. 5E, the RRC configuration may indicate that the priority rule for a channel or signal is specified in dynamic L1/L2 signaling. The example embodiments and modes of FIG. 5E encompass both L1 and L2 embodiments/implementations/realizations.

L1 realization: In one realization, a bit or a multi-bit field in a DCI is set (or reset resp.) to indicate that an associated channel or signal has a higher priority. For example, in a DCI scheduling a PDSCH, the said bit indicates that receiving the PDSCH is to be prioritized to a colliding UL transmission. As another example, in a DCI scheduling a PUSCH, the said bit indicates that transmitting the PUSCH is to be prioritized to a colliding DL reception. As yet another example, in a DCI triggering an aperiodic CSI-RS, the said bit indicates that receiving the CSI-RS is to be prioritized to a colliding UL transmission.

L2 realization: In another realization, a bit (or a multi-bit field) in a MAC CE is set (or reset resp.) to indicate that an associated channel or signal has a higher priority. For example, in a MAC CE activating a semi-persistent CSI-RS, the said bit indicates that receiving the CSI-RS is to be prioritized to a colliding UL transmission.

There are different options for the semantics of the associated RRC configuration. In one realization, a priority value in the DL-UL-Collision-Priority IE is specified to indicate that a priority of the associated channel/signal is indicated by L1/L2 signaling.

In another example implementation, embodiment and mode, or realization, a field in a configuration IE indicates that a priority bit/field is present in the associated L1/L2 signaling. For example, a field priority-Value-Present-In-DCI in a CORESET configuration IE) may indicate that a bit/field is present in the DCIs on the PDCCHs on the associated CORESET). As another example, a field priority-Indicator-DCI in a PDSCH configuration IE or a PUSCH configuration IE may indicate that a bit/field in the DCI scheduling a PDSCH or PUSCH is present to indicate a priority. In various examples, the RRC field may be configured with a value of true, enabled, or the like.

In yet another example implementation, embodiment and mode, or realization, a priority indicator bit/field in the DCI may be reused or overloaded to indicate a priority rule in the case of DL-UL collision. For example, the bit/field in the DCI configured by priorityIndicatorDCI-1-1 or priorityIndicatorDCI-1-2 in the PDSCH-Config IE or priorityIndicatorDCI-0-1 or priorityIndicatorDCI-0-2 in the PUSCH-Config IE may be reused or overloaded to indicate the said priority. In this case, an additional field in a configuration IE may indicate that the bit/field is to be reused or overloaded for DL-UL collision handling. For example, an RRC field use-Priority-Indicator-for-Collision-Handling may be configured with true or enabled to indicate the said reusing or overloading to the UE.

In response, the wireless terminal 22 uses the indicated bit/field in L1/L2 signaling to determine the priority of an associated channel/signaling when a DL-UL collision occurs.

In any of the above embodiments, if more than one channel or signal are FDM'ed, the channel or signal with the highest priority may be considered for determining whether to prioritize DL or UL. For example, if two DL channels/signals with priority values 1 and 3 are frequency division multiplexed and collide with a UL channel/signal with priority 2, and smaller (or larger resp.) priority value indicates higher priority, then DL is prioritized, hence both DL channels/signals are prioritized over the UL channel/signal.

In other words, the wireless terminal 22 uses the indicated priority of the channel/signal not only to determine the priority of the channel/signal but more generally determine whether associated time resources, (symbols or slots, are DL or UL. Then, based on this determination, the UE may receive other DL channels/signals or transmit other UL channels/signals that occur fully or partially on the said time resources, although the said other channels/signals may be assigned lower priority by the priority configuration.

In any of the above example embodiments and modes, the priority may be determined per symbol, per slot, per channel/signal, or the like. If the DL-UL priority is determined per symbol (or in some cases even per slot), a fraction of a channel/signal may be prioritized and another fraction may be deprioritized based, at least in part, on whether each symbol (or slot) on which the channel/signal occurs collides with another channel/signal with a higher or lower priority.

There are different options for handling deprioritized reception or transmission, respectively of channels/signals. In one example, the UE drops the entire channel/signal. In another example, the UE receives (or transmits resp.) the portion of the DL or UL respectively, that does not overlap with a UL transmission or DL reception respectively.

### 1F: Directional Prioritization Unless Overridden

In some example embodiments and modes, such as the example embodiments and modes of FIG. 5F and FIG. 5G, the 22 may apply additional or alternative priority rules based on the specification, implicit determination, or implementation of/at the wireless terminal 22. In other words, the collision priority rule/logic memory 27 may include logic that, in addition to the collision priority rule configuration message, is used by priority controller 28 to avoid collisions.

In some example embodiments and modes of FIG. 5F, the priority controller 28 may be configured so that a transmission in the downlink, DL, direction is prioritized over the uplink, UL, unless an RRC configuration indicates that wireless terminal 22 should be prioritized always, for certain channels/signals, for certain occurrences or occasions of channels/signals, for channels/signals on certain time and/or frequency resources, or the like. This behavior may be either specified by the standard specification or preconfigured/implemented in the UE.

Conversely, in other example embodiments and modes of FIG. 5F, the priority controller 28 may be configured so that a transmission in the uplink, UL, is prioritized over DL unless an RRC configuration indicates that DL should be prioritized always, for certain channels/signals, for certain occurrences or occasions of channels/signals, for channels/signals on certain time and/or frequency resources, or the like.

### 1G: Prioritization Based on Temporal Order

In the example embodiments and modes of FIG. 5G, channel/signal prioritization may be based on temporal order. As a first example, a first channel/signal that is scheduled, triggered, or activated by a first L1/L2 signaling is prioritized over a second channel/signal that is scheduled, triggered, or activated by a second L1/L2 signaling provided that the first L1/L2 signaling is received earlier than the second L1/L2 signaling. Examples of L1/L2 signaling are a DCI scheduling a shared channel (PDSCH, PUSCH), a DCI triggering an aperiodic reference signal (CSI-RS, SRS, etc.), a MAC CE activating a semi-persistent reference signal, or the like.

As a converse second example for the example embodiments and modes of FIG. 5Ga first channel/signal that is scheduled, triggered, or activated by a first L1/L2 signaling is prioritized over a second channel/signal that is scheduled, triggered, or activated by a second L1/L2 signaling provided that the first L1/L2 signaling is received later than the second L1/L2 signaling. Examples of L1/L2 signaling are a DCI scheduling a shared channel (PDSCH, PUSCH), a DCI triggering an aperiodic reference signal (CSI-RS, SRS, etc.), a MAC CE activating a semi-persistent reference signal, or the like.

Any of the example embodiments and modes of Section 1.0 hereof may be used as an alternative or in combination with any of the aforementioned configuration-based priority rules.

### 2.0: Timing Advance Reporting in Collision Situations

Timing advance, TA, reporting was introduced in Rel-17 for non-terrestrial networks, NTN, and was later extended in Rel-18 for air-to-ground, ATG. The current TA reporting mechanism has been shown to be insufficient for supporting half duplex frequency division duplex, HD-FDD, Reduced capability (RedCap) UEs, as the granularity and/or the supported TA reporting frequency still causes a large TA mismatch between the UE and the network.

One proposal is to increase the TA reporting frequency. But this proposal leads to a potentially large overhead for sending all the additional TA reporting medium access control, MAC, control elements, CEs. Another proposal is to specify a finer granularity for the TA reporting, but that change alone does not address the problem.

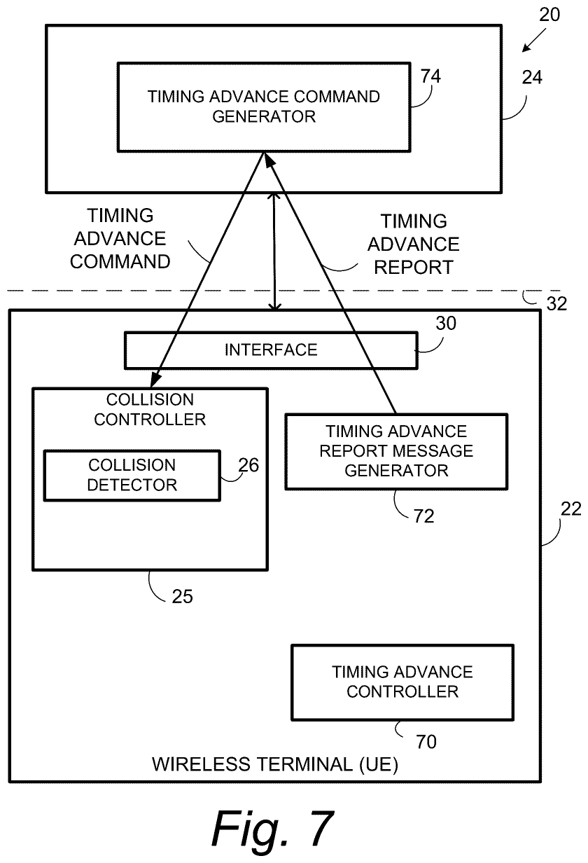

In the example embodiments and modes represented by FIG. 7, the wireless terminal 22 is configured to report the TA as ascertained by wireless terminal 22 upon determining that the UL transmission timing according to the latest decoded TA command overlaps fully or partially with a DL reception, i.e., a DL-UL collision. For example, in the example embodiments and modes of FIG. 7 a wireless terminal determines a collision condition and generates a timing advance report upon determination of a timing advance mismatch and/or the collision condition.

FIG. 7 shows wireless terminal 22 as comprising, in addition to the aforementioned collision controller 25 and/or collision detector 26, timing advance controller 70 and timing advance report generator 72. FIG. 7 also shows that network node 24 comprises timing advance command generator 74.

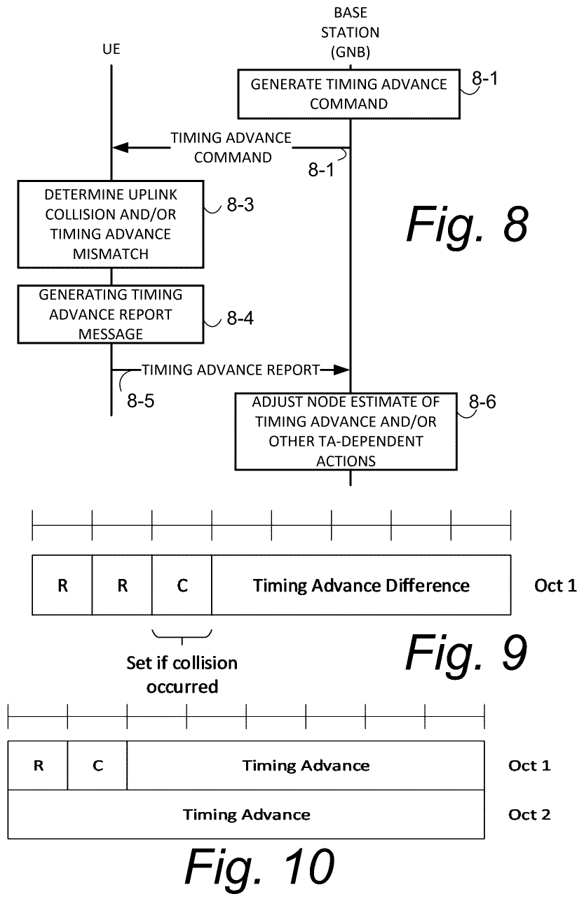

Basic example, representative, generic acts or steps which may be performed by the example embodiments and modes of FIG. 7 are shown in FIG. 8. As act 8-1, the timing advance command generator 74 generates a timing advance command which reflects or is based on a latest timing advance as determined by the network, e.g., by network node 24. Through its interface circuitry, as act 8-2 the network node 24 transmits the timing advance command over the radio or air interface 32 to network node 24. The wireless terminal interface circuitry 30 receives, from network node 24, a latest decoded timing advance, TA, command. Act 8-3 comprises the wireless terminal 22, e.g., timing advance controller 70, making a determination that an uplink transmission according to the latest decoded timing advance, TA, command would or could result in an actual or potential, e.g., anticipated, downlink-uplink collision and/or a timing advance mismatch on the radio interface. In this regard, a TA mismatch does not automatically lead to a collision but may lead to a collision if the TA mismatch is not recognized by the network, so the network scheduled DL and UL may collide. Therefore, the timing advance controller 70 should make the determination of act 8-3 as soon as it realizes there is a TA mismatch and not necessarily wait for a DL-UL schedule that is about to lead to a collision.

Act 8-4 comprises the wireless terminal 22, e.g., timing advance report generator 72, generate a timing advance, TA, report message as a result of the determination. Act 8-5 comprises the wireless terminal 22, e.g., wireless terminal interface circuitry 30, transmitting the timing advance, TA, report message to the network node over the radio interface. Examples of the TA report message of act 8-5 are illustrated and discussed below in conjunction with FIG. 9 and FIG. 10. As mentioned above, preferably act 8-4 and act 8-5 are performed as soon as the wireless terminal 22 realizes that there is a TA mismatch, rather than the wireless terminal 22 necessarily waiting for a DL-UL scheduling that may lead to a collision.

Upon receiving the TA report message, of act 8-5, as act 8-6 the network node 24 may adjust its estimate of the TA value for communications with wireless terminal 22 according to the value of Timing Advance. Act 8-6 may be performed, for example, upon receipt of the TA report messages having formats shown in FIG. 9 and FIG. 10 and may also be performed in conjunction with other example embodiments and modes hereof, including but not limited to the example embodiments and modes of FIG. 12 and of Section 4.0 hereof. This TA value adjustment of act 8-6 may trigger sending a new TA command by network node 24 to wireless terminal 22 that comprises the adjusted TA value. Additionally, the network node 24 may perform other acts. As one example of such other acts, the said TA adjustment received by network node 24 may result in the network node 24 rescheduling or canceling a DL or a UL to avoid a DL-UL collision. This may result in a signaling to wireless terminal 22 that reschedules or cancels the said DL or the said UL. As another example, network node 24 may expect that wireless terminal 22 resolves the DL-UL collision, for example, by prioritizing the said DL or the said UL. The resolution by wireless terminal 22 may follow a configuration or indication by 24 according to embodiment so the present invention. In the former case, i.e., when wireless terminal 22 is expected to prioritize the DL, the network node 24 may not expect to receive the said UL from wireless terminal 22. In the latter case, i.e., when wireless terminal 22 is expected to prioritize the said UL, the network node 24 may reschedule the DL before receiving a NACK message indicating that wireless terminal 22 did not receive the said DL. Furthermore, if the bit/field “C” indicates that a collision has occurred or is about to occur, 24 may use the information to anticipate the behavior of wireless terminal 22 in the face of the collision and act accordingly, e.g., reschedule a DL or a UL or expect wireless terminal 22 to prioritize the DL or the UL. Additionally, or alternatively, if 24 receives information of whether DL or UL was prioritized by wireless terminal 22 (according to the example of FIG. 12) it may use the information to expect that wireless terminal 22 did not receive the DL (if UL is indicated prioritized) or did not transmit the UL (if DL is indicated prioritized). In response, network node 24 may reschedule the deprioritized the DL or the UL, respectively, potentially prior to receiving an associated NACK message in some examples.

In an example implementation of the example embodiments and modes of FIG. 7, the wireless terminal 22 is configured to send a TA report, e.g., the timing advance report of act 8-5, upon detecting a DL-UL collision, e.g., as act 8-4. Since DL-UL collisions may occur in succession, in an example implementation the wireless terminal 22 does not send another TA report for a certain period, e.g., for a predetermined time, after a previous TA report. Expiration of the period or predetermined time may, in an example embodiment and mode, be determined based on a timer. The timer may be configured by the network.

In non-limited, example implementations of the example embodiments and modes of FIG. 7, the TA report does not necessarily comprise a full TA value. Instead, the TA report may comprise one or multiple of the following:
The difference between the last reported TA and the current TA.
The difference between the TA based on the latest received TA command and the current TA.

Thus, in some example embodiments and modes, the timing advance report message may comprise at least one of:
a second timing advance value;
a difference between the second timing advance value and a latest timing advance value previously reported;
a first indication that at least one downlink channel/signal and at least one uplink channel/signal overlapped by at least one symbol;
a second indication of the downlink channel/signal and a third indication of the uplink channel/signal; and
a fourth indication of whether the downlink channel/signal was prioritized by the UE or the uplink channel/signal was prioritized by the wireless terminal.

In an example embodiment and mode, the MAC CE may further indicate whether the TA mismatch has led to a DL-UL collision. For example, FIG. 9 illustrates an example format of the new TA report, which may be referred to as a TA Mismatch Report MAC CE, TA Difference Report MAC CE, DL-UL Collision Indication MA CE, or the like. In this example, the bit/field “C” is set if a DL-UL collision has occurred or is about to occur. The bit “C” is set if the TA mismatch is leading to a collision, or the collision has occurred. Otherwise, the MAC CE may, but does not necessarily, mean that there is a TA mismatch that may cause a collision in the future.

In another example embodiment and mode, as illustrated in FIG. 10, one of the reserved bits in the existing TA Report MAC CE may be used to indicate that a DL-UL collision has occurred. In this example, the bit/field “C” is set if a DL-UL collision has occurred or is about to occur.

### 3.0: Reporting of Collision

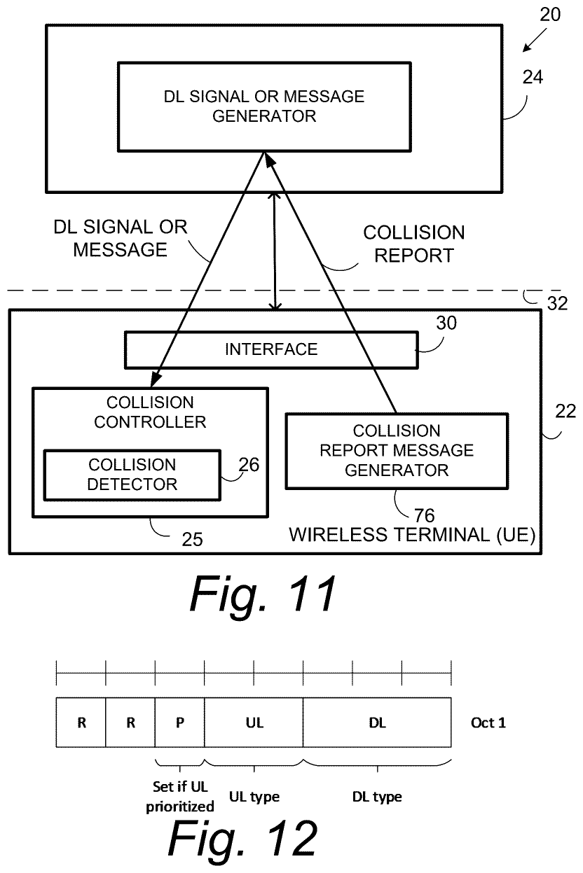

In the example embodiments and modes of FIG. 11 the wireless terminal 22 generates and transmits a new collision report or collision indication, which may be a new message or a portion, e.g., information element, of an existing message. FIG. 11 shows wireless terminal 22 as comprising collision report generator 76.

In an example embodiment and mode, the collision report generator 76 is configured to generate the collision report as or to be included in a medium access control, MAC, control element, CE. In an example implementation, the format of the MAC CE is specified to report to the network that a DL-UL collision occurred. The new MAC CE may be called a DL-UL Collision Indication MAC CE, and it may comprise information of one or multiple of the following:
The number of colliding symbols or slots, i.e., the duration of the overlap between the DL and UL channels/signals.
The type of the DL and UL channels/signals that collided.
Whether the UE prioritized DL or UL in the said collision(s).

In an example embodiment and mode, the length of the new MAC CE can be as small as one octet to keep the resource overhead to a minimum, as shown in example fashion in FIG. 12.

In some example implementations of the example embodiments and modes of FIG. 11, the wireless terminal 22 does not send another DL-UL Collision Indication MAC CE for a certain period, which can be determined based on a timer. The timer may be configured by the network.

In some non-limiting, example implementations of the example embodiments and modes of the technology disclosed herein, the timing advance report may include one or more of the following:
a first indication that at least one downlink channel/signal and at least one uplink channel/signal overlapped by at least one symbol;
a second indication of the downlink channel/signal and a third indication of the uplink channel/signal; and
a fourth indication of whether the downlink channel/signal was prioritized by the UE or the uplink channel/signal was prioritized by the UE.

Thus, the wireless terminal 22 of the example embodiments and modes of FIG. 11 may perform a method comprising the following acts of:
determining that there is a mismatch between a first timing advance according to a latest timing advance command from a network and a second timing advance as measured by the UE; and
sending a message to the network, wherein the message comprises at least one of:
   the second timing advance value;
   a difference between the second timing advance value and a latest timing advance value previously reported;
   a first indication that at least one downlink channel/signal and at least one uplink channel/signal overlapped by at least one symbol;
   a second indication of the downlink channel/signal and a third indication of the uplink channel/signal; and a fourth indication of whether the downlink channel/signal was prioritized by the UE or the uplink channel/signal was prioritized by the UE.

### 4.0: UE Reporting Collision or TA Mismatch in UCI

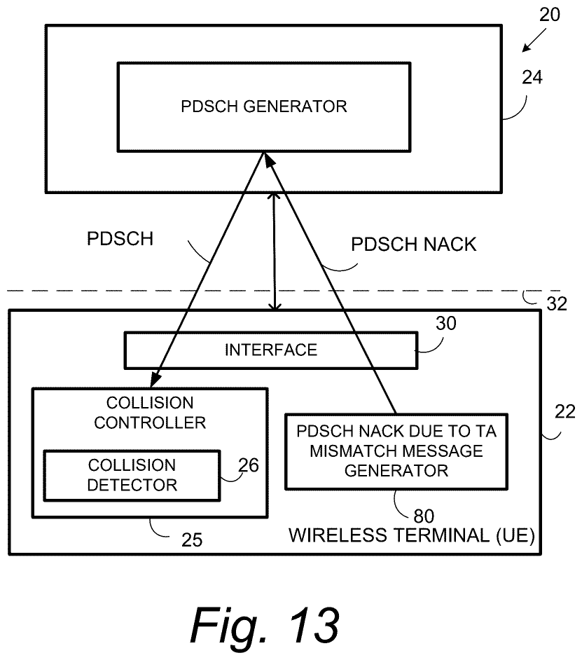

According to other example embodiments and modes illustrated by way of example in FIG. 13, if a wireless terminal 22, UE, is scheduled, e.g., by a dynamic grant, DG, or configured, e.g., through a semi-persistent scheduled, SPS, configuration to receive a PDSCH, a bit in uplink control information, UCI, carrying the HARQ NACK message, e.g., a NACK message generated in response to an occurrence of the PDSCH, is set, or reset, respectively, to carry the information that the PDSCH was not received due to a DL-UL collision that was caused by a TA mismatch between the UE and the network entity, e.g., a base station, that transmitted the PDSCH. FIG. 13 shows wireless terminal 22 as comprising PDSCH NACK due to timing advance mismatch message generator 80.

For the example embodiments and modes of FIG. 13, the wireless terminal 22 may be configured to set, or reset, respectively, a bit/field in the uplink control information, UCI, to indicate the TA mismatch, the DL-UL collision, a DL-UL overlap larger than a threshold, or the like.

Listing 7 is an example ASN.1 code according to which a parameter in an RRC IE such as PhysicalCellGroupConfig indicates that the HARQ NACK comprises a bit/field indicating that a PDSCH was not received because it was deprioritized due to a DL-UL collision.

Listing 7

```
PhysicalCellGroupConfig ::= SEQUENCE {
  ...
  deprioritize-Indication-In-HARQ-NACK ENUMERATED {true} OPTIONAL,
  ...
}
```

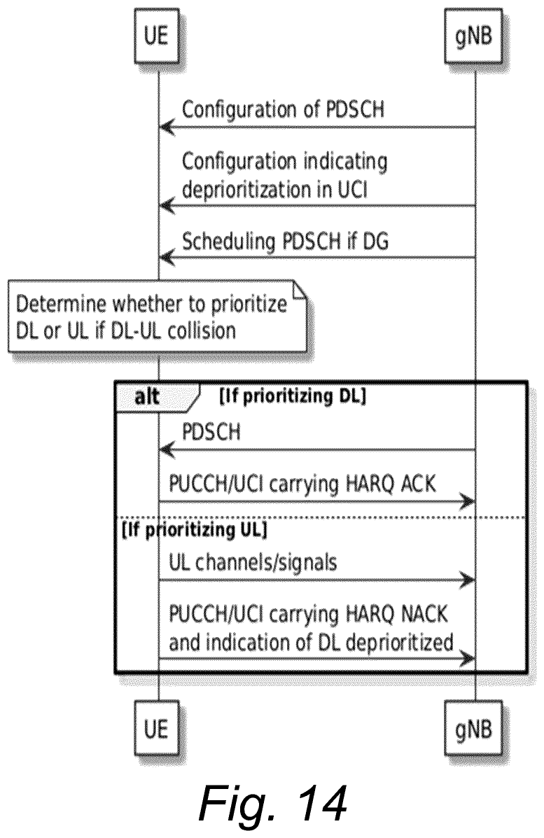

The example embodiments and modes of FIG. 13 and methods implemented thereby, as illustrated by way of example in FIG. 14, allow a low-latency and low-overhead indication from the UE to the network to take action for correcting the network's estimate of the TA associated with the said UE, and potentially other UEs in its vicinity. Absent the said bit/field, which is the case in the current specification, a separate signaling is needed to convey such information to the network, which adds latency and signaling overhead. If the information is not conveyed to the network, the network may not be able to determine whether the UE's failure to receive the PDSCH was due to low signal quality or due to a TA mismatch that led to a DL-UL collision. FIG. 14 provides an example illustration of an example timeline for the example embodiments and modes of FIG. 13.

### 5.0: Diversity by Pusch Repetition

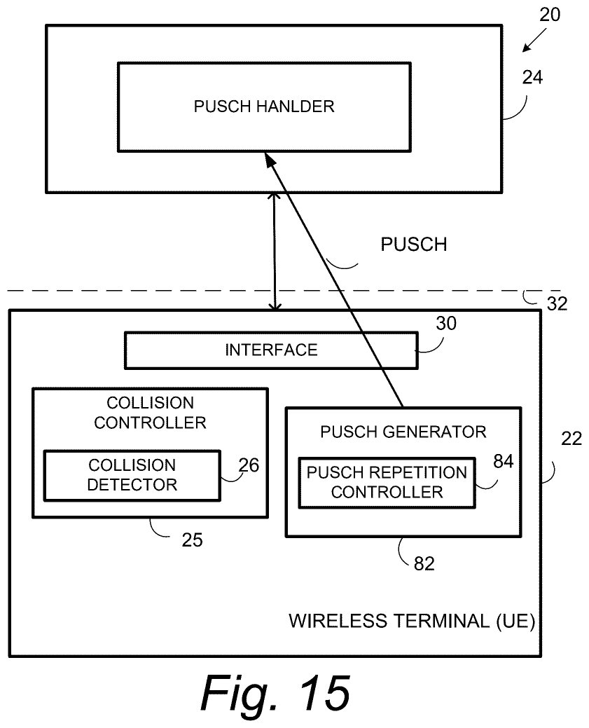

In the example embodiments and modes of FIG. 15, a wireless terminal 22 is scheduled (DG) or configured (CG) with a PUSCH with repetition, for example a repetition type A or type B. Then, the UE follows rules to transmit a TB in some repetitions of the PUSCH to satisfy a threshold and discard the rest of the repetitions. FIG. 15 shows wireless terminal 22 as comprising PUSCH generator 82 and PUSCH repetition controller 84. The PUSCH repetition controller 84 is configured to determine what repetitions of the PUSCH are permitted to be transmitted over radio or air interface 32 to network node 24.

In an example implementation of the example embodiments and modes of FIG. 15, the wireless terminal 22 is configured with a PUSCH with repetition type A. Let N denote the number of repetitions indicated by the configuration. The wireless terminal 22 is further configured to transmit at least M out of the N repetitions to satisfy a minimum signal quality perceived by the network. The wireless terminal 22 is further configured with priority rules for handling collision between each PUSCH repetition and (dynamically scheduled) DL channels/signals. In some realizations, the wireless terminal 22 may consider “soft” priority rules to satisfy the condition of at least M out of the N repetitions.

In another example implementation of the example embodiments and modes of FIG. 15, the values of parameters N and M are configured or indicated by the network. Soft rules specified by the standard or configured by the network may allow the 22 to prioritize transmitting a PUSCH repetition over receiving a colliding DL channel/signal if the UE realizes that transmitting the PUSCH repetition is needed to satisfy the M-out-of-N constraint configured by the network; otherwise, the UE may prioritize receiving the said DL channel/signal over transmitting the said PUSCH repetition.

In another example implementation of the example embodiments and modes of FIG. 15, the 22 is configured with a PUSCH with repetition type B. The wireless terminal 22 is further configured to transmit at least K whole symbols, i.e., symbols without muting, over all the actual repetitions, or at least M whole actual repetitions, to satisfy a minimum signal quality perceived by the network. The wireless terminal 22 is further configured with priority rules for considering invalid symbols when symbols in a PUSCH repetition collide with (dynamically scheduled) DL channels/signals. In some realizations, the UE may consider “soft” priority rules to satisfy the condition of K whole symbols or M whole actual repetitions.

In some example implementations of the foregoing, the value of parameters K or M are configured or indicated by the network. Soft rules specified by the standard or configured by the network may allow the UE to decide whether a symbol is invalid for a PUSCH repetition based, at least in part, on determining whether the constraints configured by the parameters K or M are satisfied if the said symbol is considered invalid for the said PUSCH repetition.

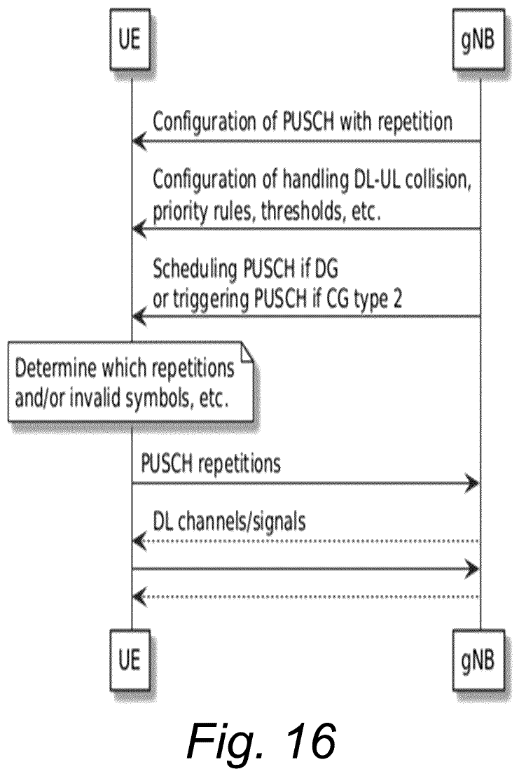

FIG. 16 shows an example timeline of acts, steps, and signals involved in a non-limiting method for the example embodiments and modes of FIG. 15.

### FURTHER CONSIDERATIONS

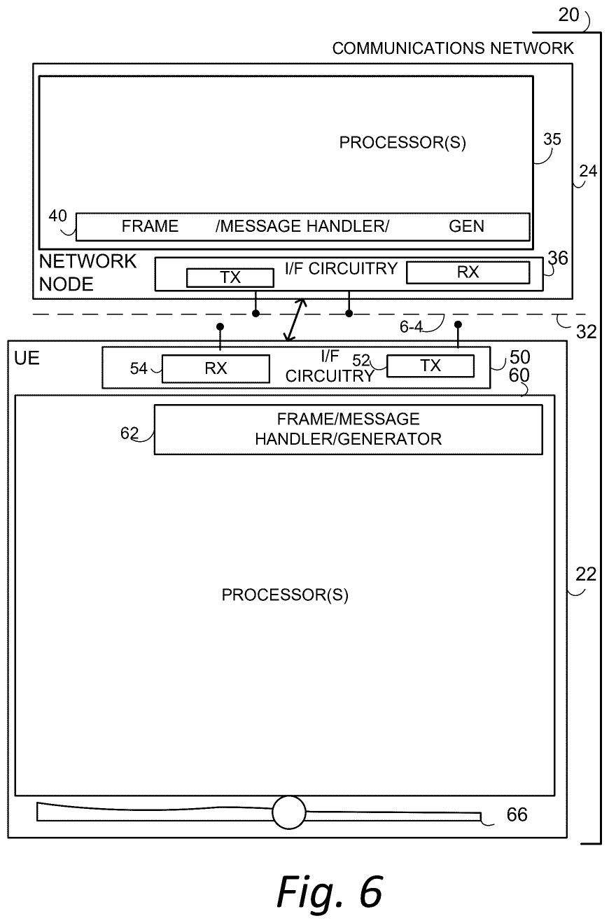

FIG. 6 shows in more detail various selected units and functionalities of the exemplary communications system 20 suitable for implementation of the example embodiments and modes hereof. The example units and functionalities illustrated in FIG. 6 and figures for the example embodiments and modes hereof are not limiting, e.g., various units and functionalities may be omitted in some implementations and other units and functionalities not illustrated herein may be included.

FIG. 6 shows network node 24 as including network node processor circuitry which may comprise one or more network node processors 35, as well as network node transceiver circuitry 36, which may also be referred to as network node interface circuitry. The network node processors 35 are also referred to herein as “at least one processor”, and as such may comprise processor circuitry which individually and/or collectively are configured to perform the acts described herein. The following units and functionalities described herein are non-limiting examples of units and functionalities that may be implemented by machinery and processor circuitry, e.g., by at least one processor, network node processors 35: collision priority rule configuration message generator 34, timing advance command generator 74; DL signal or message generator; PDSCH message generator; PUSCH handler.

As illustrated in FIG. 6, the network node transceiver circuitry 36 may comprise a transmission and reception point (TRP). The transmission and reception point (TRP) 36 may further comprise transmitter circuitry and receiver circuitry. The network node processors 35 may comprise message processors such as message/frame handler/formatter 40 which prepares and/or processes messages transmitted to or received from wireless terminal 22.

FIG. 6 also shows various example constituent components and functionalities of wireless terminal 22. For example, FIG. 6 shows wireless terminal 30 as comprising wireless terminal transceiver circuitry 50, which in turn may comprise transmitter circuitry 52 and receiver circuitry 54. The transmitter node transceiver circuitry 50 may include antenna (e) for the wireless transmission. Transmitter circuitry 52 may include, e.g., amplifier(s), modulation circuitry and other conventional transmission equipment. Receiver circuitry 54 may comprise, e.g., amplifiers, demodulation circuitry, and other conventional receiver equipment.

FIG. 6 further shows wireless terminal 22 also comprising wireless terminal processor circuitry, e.g., one or more wireless terminal processor(s) 60. The wireless terminal processor(s) 60 are also referred to herein as “at least one processor”, and as such may comprise processor circuitry which individually and/or collectively are configured to perform the acts described herein. The wireless terminal 22, e.g., wireless terminal processor(s) 60, may comprise wireless terminal frame or message handler/generator 62, as well as the other functionalities described herein. For example, the at least one processor, e.g., wireless terminal processor(s) 60, may comprise or perform the functions of collision controller 25; collision detector 26; collision priority rule/logic memory 27; priority controller 28; timing advance controller 70; timing advance report generator 72; timing advance command generator 74; collision report generator 76; and the PDSCH NACK due to timing advance mismatch message generator 80.

The wireless terminal 22 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

The wireless terminal 22 of FIG. 6 may also comprise one or more unillustrated data buffers or packet buffers into which packets destined for transmission over radio or air interface 32 from the wireless terminal 22 may be stored before pre-processing by the wireless terminal 22 and/or packets from network node 24 and received at the wireless terminal 22 may be stored after post processing by wireless terminal 22. Packets may be packets that are inbound to wireless terminal 22 from either one or more applications executed by wireless terminal processor(s) 60, or received from unillustrated other nodes to which the wireless terminal 22 may be connected.

The example embodiments and modes hereof also encompasses a computer program product in which processor circuitry or the like, such as wireless terminal processor(s) 60, execute instructions stored on a non-transient memory to perform acts such as those described herein.

The outlined captions hereof are not technically limiting but only for textual organizational.

For the foregoing example embodiments and modes, units and functionalities of any example embodiment and mode which have the same reference numbers of other example embodiments and modes should be understood to be the same as structure and operation even if not discussed in the context of the example embodiment and mode, unless otherwise clear from the context.

As mentioned above, aspects of one or more of the various example embodiments and modes may be used in combination with one or more example embodiments and modes. For example, one or more of the example embodiments and modes hereof may be used in combination with one or more of the example embodiments and modes. Moreover, while some of the illustrations for the various example embodiments and modes of are shown as including structures, features, or acts of other example embodiments and modes, it should be understood that in some cases not all such structures, features, or acts of preceding and/or other example embodiments and modes need necessarily be included in order to accomplish the objectives of the discussed example embodiment and mode.

Each of the example embodiments and modes discussed herein encompass a computer program product in which processor circuitry or the like, such as wireless terminal processor(s) 60 and network node processors 35, execute instructions stored on a non-transient memory to perform acts such as those above described.

In terms of wireless communication, the wireless terminal 22 may be either a wireless terminal such as user equipment or mobile station, or a network node. Similarly and conversely, the network node 24 may be either a wireless terminal such as user equipment or mobile station, or a network node. It should be understood that herein “network” may be used interchangeably with “network node”. A network node may be either a core network node or a node of a radio access network, such as a RAN access node, e.g., a base station node, for example. The wireless terminal UE may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

A core network may comprise one or more core network nodes. A core network node may comprise or be realized by any suitable type of core network node entities, such as a core network management entity, e.g., an Access and Mobility Management Function (AMF). A core network and one or more of its constituent core network nodes is connected to at least one radio access network through a core-RAN interface circuit.

A radio access network in turn comprises one or more radio access network (RAN) nodes, such as a base station node. The base station node serves at least one cell. The radio access network, RAN, typically comprises plural access nodes. A base station node may have architecture such as split architecture comprising a central unit and one or more distributed units that comprise mobile termination (MT).

It should be understood that the various foregoing example embodiments and modes may be utilized in conjunction with one or more example embodiments and modes described herein. For example, the example embodiments and modes of all aspects of the technology disclosed herein, may be utilized in combination with one or more other example embodiments and modes disclosed herein.

Certain units and functionalities of the communications systems may be implemented by electronic machinery. For example, electronic machinery may refer to the processor circuitry described herein, such as network node processors 34 and wireless terminal processor(s) 60. Moreover, the term “processor circuitry” is not limited to mean one processor, but may include plural processors, with the plural processors operating at one or more sites, and with the at least one processor, e.g., plural processors, operating independently and/or concurrently. Moreover, as used herein the term “server” is not confined to one server unit but may encompass plural servers and/or other electronic equipment and may be co-located at one site or distributed to different sites.

The foregoing are not exhaustive lists as other units and functionalities may also be implemented by processor circuitry.

With these understandings, FIG. 17 shows an example of electronic machinery, e.g., processor circuitry, as comprising one or more processors 490, program instruction memory 492; other memory 494 (e.g., RAM, cache, etc.); input/output interfaces 496 and 497, peripheral interfaces 498; support circuits 499; and busses 500 for communication between the aforementioned units. The processor(s) 490 may comprise the processor circuitries described herein, for example, network node processors 34 and wireless terminal processor(s) 60.

A memory or register described herein may be depicted by memory 494, or any computer-readable medium, may be one or more of readily available memory such as random-access memory (RAM), read only memory (ROM), floppy disk, hard disk, flash memory or any other form of digital storage, local or remote, and is preferably of non-volatile nature, as and such may comprise memory. The support circuits 499 are coupled to the processors 490 for supporting the processor in a conventional manner. These circuits include cache, power supplies, clock circuits, input/output circuitry and subsystems, and the like.

The processes and methods of the disclosed embodiments may be implemented as a software routine. Alternatively or additionally, some or all of method steps that are disclosed therein may be performed in hardware as well as by a processor running software. As such, the embodiments may be implemented in software, as executed upon a computer system, in hardware as an application specific integrated circuit or other type of hardware implementation, or a combination of software and hardware. The software routines of the disclosed embodiments are capable of being executed on any computer operating system and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus, machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The acts described herein may be performed by a software program product stored tangibly on a non-transient computer-readable medium which, when executed by one or more processors as herein mentioned, performs such acts either in whole or in part.

Moreover, each functional block or various features of the wireless terminal 22 and network node 24 employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves, e.g., interference in a communications system.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

1-15. (canceled)

16. A half-duplex user equipment (HD-UE) operating in a non-terrestrial network (NTN) cell, the HD-UE comprising:
interface circuitry configured to:
receive a first schedule of a downlink channel/signal and a second schedule of an uplink channel/signal, wherein the uplink channel/signal overlaps with the downlink channel/signal; and
at least one processor comprising processor circuitry, the processor circuitry configured individually and/or collectively to:
make a first determination, in a case that a configuration indicating for a reduced capability (RedCap) in the NTN cell is received, whether to transmit the uplink channel/signal based on the configuration, and
make a second determination, in a case that the configuration is not received, whether to transmit the uplink channel/signal based on a temporal order of the first schedule of the downlink channel/signal.

17. The user equipment according to claim 16, wherein:
the first determination comprises determining, in a case that the configuration indicating to prioritize the uplink channel/signal for the RedCap in the NTN cell is received, to transmit the uplink channel/signal based on the configuration, and
the second determination comprises determining, in a case that the configuration is not received, to transmit the uplink channel/signal based on the temporal order of the first schedule of the downlink channel/signal.

18. A method performed by a half-duplex user equipment (HD-UE) operating in a non-terrestrial network (NTN) cell, the method comprising:
receiving a first schedule of a downlink channel/signal and a second schedule of an uplink channel/signal, wherein the uplink channel/signal overlaps with the downlink channel/signal;
making a first determination, in a case that a configuration indicating for a reduced capability (RedCap) in the NTN cell is received, whether to transmit the uplink channel/signal based on the configuration; and
making a second determination, in a case that the configuration is not received, whether to transmit the uplink channel/signal based on a temporal order of the first schedule of the downlink channel/signal.

19. A half-duplex base station apparatus operating in a non-terrestrial network (NTN) cell, the half-duplex base station apparatus comprising:
interface circuitry configured to:
transmit a first schedule of a downlink channel/signal and a second schedule of an uplink channel/signal, wherein the uplink channel/signal overlaps with the downlink channel/signal; and
at least one processor comprising processor circuitry, the processor circuitry configured individually and/or collectively to:
make a first determination, in a case that a configuration indicating for a reduced capability (RedCap) in the NTN cell is provided, whether to transmit the uplink channel/signal based on the configuration, and
make a second determination, in a case that the configuration is not provided, whether to transmit the uplink channel/signal based on a temporal order of the first schedule of the downlink channel/signal.
